(19) United States
(12) Patent Application Publication
(10) Pub. No.: US 2018/0067317 A1
(43) Pub. Date: Mar. 8, 2018

(54) HEAD MOUNTED DISPLAY WITH REDUCED THICKNESS USING A SINGLE AXIS OPTICAL SYSTEM

(71) Applicant: Allomind, Inc., Arcadia, CA (US)

(72) Inventors: STEPHEN BARTON, San Jose, CA (US); GOH KEE SIANG, San Jose, CA (US); ABHIJIT LIMAYE, San Jose, CA (US); SCOTT CAHALL, San Jose, CA (US); ROMAN GUTIERREZ, Arcadia, CA (US)

(73) Assignee: Allomind, Inc., Arcadia, CA (US)

(21) Appl. No.: 15/697,415

(22) Filed: Sep. 6, 2017

Related U.S. Application Data
(60) Provisional application No. 62/383,836, filed on Sep. 6, 2016.

(51) Int. Cl. G02B 27/01

(52) U.S. Cl. CPC G02B 27/0172; G02B 27/0176

(57) ABSTRACT

Systems and apparatuses are provided for reducing the focal length of a head mounted display (HMD) while maintaining image quality and providing diopter adjustment for a user of the HMD. A lens stack comprising a plurality of lenses provides negative and positive focal length to achieve a traditional eye box. The lens stack is positioned along the same optical axis as the user's line of sight, while still achieving a small form factor with a reduced total track length,

### RELATED APPLICATIONS

This application claims the benefit of U.S. Provisional Patent Application No. 62/383,836, filed Sep. 2, 2016, the content of which is incorporated herein by reference in its entirety.

### TECHNICAL FIELD

This disclosure relates to head mounted display (HMD) systems in general, and in particular, to (HMD) systems using a single axis optical system with reduced focal length and thickness.

### BACKGROUND

HMDs generally refer to display devices that can be worn on a user's head or on the face, in which one or more display optics are positioned in front of the user's eye(s). Some HMDs utilize the display optics to present a virtual image or scene, i.e., a virtual reality (VR) experience. Some HMDs utilize the one or more display optics to present images or visual elements superimposed on a real-world view, i.e., an augmented reality (AR) experience.

In some configurations, the one or more display optics include one or more mirrors and/or prisms, as well as one or more micro-displays. A lens or an optical system is generally used to project a larger virtual image of the display than would otherwise be observable through direct view of the display. A typical distance for a virtual image is more than about 50 cm.

Conventional HMDs may either use an on-axis, magnifier lens element or system of elements to create a virtual image in front of the user's eye(s), or a system of lenses or mirrors in combination with a prism or beam-splitter in order to project a virtual image, as alluded to previously. With either of these methods, the result is an HMD with increased complexity due to the addition of the prism or beam-splitter. Examples of systems with a rear beam-splitter include U.S. Pat. No. 6,349,004, US 2004/0165278, and US 2004/0165283.

FIG. 1A illustrates a side view of one example of a conventional HMD that utilizes an optical system 10 comprising a display 14, and a prism 16. It should be noted that the conventional HMD may utilize two such optical systems, one for each eye of a user. However, only one optical system will be described for simplicity. As illustrated in FIG. 1A, display 14, may be a display used to project/present an image (represented by rays, one of which is ray 15). Prism 16 can be used to magnify and direct the image from display 14 to the user's eye 12. However, with folded optics, the system is only 25% efficient. The image can be seen in eye box 18 and the user can experience a VR/AR scene. It should be noted that to effectuate an AR scene, outside or real-world images may pass through to the user's eye 12 and also seen in eye box 18. In other conventional HMDs, a single optical system having, e.g., one large display can be utilized, where a physical divider can be used such that each eye only sees its version of the intended image.

FIG. 1B illustrates a side view of another example of a conventional HMD that utilizes an optical system 20 comprising a display 24, a beam-splitter (e.g., a polarizing beam-splitter) 22, and a curved mirror 26. As in the previous example, it should be noted that the conventional HMD may utilize two such optical systems, one for each eye of a user. However, only one optical system will be described for simplicity. As illustrated in FIG. 1B, display 14, may be a display used to project/present an image (represented by rays, one of which is ray 15). Here, the image from display 24 can be projected onto beam-splitter 22, reflected onto mirror 26, which can be a concave mirror, and ultimately directed to the user's eye 12 and seen in eye box 28.

FIG. 1D illustrates a side view of another example of a conventional HMD that utilizes an optical system comprising a curved field 20, a flat or nearly flat faceplate 41 located adjacent to an object being viewed at location 19, a beam-splitter 47 (e.g., a polarizing beam-splitter), and a system of lenses 42-44 (lens 44 having a spherical rear surface 45 and an aspherical front surface 46) to present a magnified view of a display to a user's eye(s) 12, where lenses and a display may reside on the same axis, but a 45 degree fold is utilized for illumination between the lenses and display.

In general, there are deficiencies with these HMD forms due to the requirement for space for a beam-splitter. The large space this takes up in FIG. 1C, for example, increases the overall length of the system and complicates the lens design. For example, regarding US 2004/0165278, and US 2004/0165283, the total track length (TTL), equal to the distance from the front vertex to a display surface is at least 17.2 mm. The disclosed effective focal length (or EFL or simply focal length) of these lenses is approximately 13.05 mm. One parameter for comparing the size or length of HMD systems of varying EFL is to consider the TTL/EFL ratio. For these systems, that ratio is >1.31×, which is quite long. Another useful parameter to consider as a measure of length is the TTL/display diagonal ratio. The disclosed display diagonal for these cases is 4.8 mm, corresponding to a TTL/display diagonal ratio of >3.5×, also quite long.

Another consideration when evaluating optical design forms is the complexity of the optical elements. In both U.S. Pat. No. 6,349,004 and US 2004/0165278, the disclosed forms incorporate diffractive surfaces. Diffractive surfaces are known to be more challenging to manufacture than conventional spherical or aspheric surfaces. They are also known to result in undesirable stray light artifacts when used in broad (visible) spectrum applications, which is generally the case with HMD systems.

Another deficiency of the above-mentioned prior art is in field of view (FOV). The diagonal FOV for all of the above art is in the range of 21-28 degrees full diagonal. While this may be suitable for some applications, it is clearly too narrow for immersive viewing and would give users a sense of “tunnel vision.”

Another concern about the above-mentioned prior art is image quality. These systems were all designed for displays with modest resolution. For example, US 2004/0165278, and US 2004/0165283 indicate 0.012 mm pixels in a 320×240 array. This corresponds to quarter VGA (QVGA). This was state-of-the-art at the time it was developed, and the disclosed lenses seem well-matched to this. However, it does not have suitable resolution for modern displays.

In general, conventional HMDs which use a single lens suffer from the inability to produce a sharp image due to the use of a single lens, for example. Some conventional HMDs use large displays behind the optics such as two separate panels (one for each eye) or a single OLED panel for both eyes such as with a cell phone. Due to the large size of the screen, the lenses need to maintain a larger focal length. To achieve a higher field of view (FOV), some HMDs use Fresnel or Hybrid Fresnel lenses. However, these lenses are not able to focus the source video to finest details (as shown by the display) and present an inherent challenge with meeting the high degree of acutance (sharpness of the image), and result in lower overall quality of the picture. In other words, the resolution provided by these lenses is lower than the resolution available on the display(s) behind the optics.

In particular, a single lens or Fresnel lens is used to achieve a wider FOV. However, the spot size (acutance) using such lenses is rather large resulting in a blurry image. With such a large spot size, an image having lower sharpness will be produced. Thus, even though the display can produce a sharp image, the user is unable to experience that sharpness through the optical system.

Some conventional HMDs may be designed to utilize multiple lenses, e.g., up to ten lens elements. While such a design can result in better spot size, the system length undesirably increases.

An example of a conventional HMD 30 illustrated in FIG. 1C, is one example where a smart phone display or two individual display for each eye may be utilized. In such HMDs, the lenses can be either multi-element lenses or a single lens element such as the aforementioned Fresnel or Hybrid Fresnel lens. In either case, given the large size of the display(s) behind the lenses, the overall system length is correspondingly large. A common parameter used to describe overall system length is TTL. TTL represents the distance from the distal or farthest away lens surface to the display surface. To a great extent, TTL scales with the size of the display area. A compact TTL is greatly facilitated by having a small display.

Some conventional HMDs make use of a multi-axis optical system using mirrors and/or prisms, as described above, to achieve a shorter TTL. However, this can still result in an overall increase in size of the HMD as well as significantly increased complexity and cost. For example, the TTL of conventional HMDs utilizing prisms and/or mirrors can reduce the total “thickness” of the HMD from eye to display, but increase the form factor and complexity. It should be noted that the optical total track can remain the same except that the optical path is folded from, e.g., the Z axis to the X or Y axis, where TTL refers to the distance from the top of the display surface to the top of the last optical element in an assembly. Moreover, focus adjustments may require a complex rail system that moves the displays themselves to accommodate for the different diopter requirements of different users. Additionally, such a folding of optics may require highly precise alignment of each lens elements and the folding optics (mirror or prism). This can significantly increase the cost (due to the highly complex assembly), the number of optical elements, and ultimately, the weight of the HMD system.

In HMDs with large displays that do not rely on prisms and/or mirrors, where the display(s) are positioned with their surface normals substantially parallel to the direction of sight, the Z thickness (or optical axis) is large, creating a large form factor, due to the large display. If these HMDs use a single lens element, they will be deficient in achieving a small spot size which will cause blurry images.

Per the above discussion, it is evident that there is currently a deficiency in the prior art in terms of combined TTL, image quality, and simplicity for HMDs. We present a system which incorporates a small, high resolution display in combination with a well-matched, short TTL, multi-element lens suitable for ease of manufacturing and compact form factor.

### BRIEF SUMMARY OF THE DISCLOSURE

In accordance with one embodiment, a system comprises a display and a plurality of optical lens elements. Each of the plurality of optical lens elements are configured such that, in combination, a positive focal length and a negative focal length are provided to guide one or more light rays representative of an image generated by the display to achieve an eye box capable of replicating natural eye movement of a user of the system.

In accordance with another embodiment, an HMD system comprises a frame, and a seating plane integrated into the frame. The system further comprises a lens holder fixedly mounted to the seating plane and configured to adjustably hold a lens barrel in which a lens stack is integrated to provide rotatable diopter adjustment. The lens stack comprises a plurality of lenses, wherein each of the plurality of lenses are configured such that, in combination, a positive focal length and a negative focal length are provided to guide one or more light rays representative of an image generated by a display mounted in the lens holder. The lens stack is positioned along a line of sight axis of an eye of a user of the HMD system such that surfaces of the lens stack are perpendicular to the line of sight axis of the eye of the user.

In accordance with still another embodiment, an HMD system comprises an eyeglass frame and two seating planes integrated into the eyeglass frame, each of the two seating planes positioned to be in front of and proximate to each eye of a user wearing eyeglass frame. The HMD system further comprises two lens holders, wherein each of the two lens holders are fixedly mounted to a respective one of the two seating planes and each configured to adjustably hold a lens barrel in which a lens stack is integrated to provide rotatable diopter adjustment. The lens stack comprises a plurality of lenses, wherein each of the plurality of lenses are configured such that, in combination, a positive focal length and a negative focal length are provided to guide one or more light rays representative of an image generated by a display mounted in the lens holder to achieve an eye box associated with each eye of the user capable of replicating natural eye movement of each eye. Each lens stack is positioned in line with an optical axis of each eye of the user.

### BRIEF DESCRIPTION OF THE DRAWINGS

The present disclosure, in accordance with one or more various embodiments, is described in detail with reference to the following figures.

FIG. 1A illustrates a side view of one example of a conventional HMD system.

FIG. 1B illustrates a side view of another example of a conventional HMD system.

FIG. 1C illustrates a top view of an example conventional HMD.

FIG. 1D illustrates a side view of an example optics assembly of the conventional HMD of FIG. 1C.

FIG. 2A illustrates a top view of an example of a single axis optical system in accordance with one embodiment of the present disclosure.

FIG. 2B illustrates example image/light rays propagating through the single axis optical system of FIG. 2A.

FIG. 2C illustrates another example of image/light rays propagating through the single axis optical system of FIG. 2A.

FIG. 2D illustrates a top view of another example of a single axis optical system in accordance with another embodiment of the present disclosure.

FIG. 2E illustrates example image/light rays propagating through the single axis optical system of FIG. 2D.

FIG. 2F illustrates a side view of another alternative embodiment of a single axis optical system.

FIG. 2G illustrates example light/image rays propagating through the single axis optical system of FIG. 2F.

FIG. 3A illustrates an exploded perspective view of a single axis optical assembly in accordance with one embodiment of the present disclosure.

FIG. 3B illustrates a top view of the completed single axis optical assembly of FIG. 3A.

FIG. 3C illustrates an exploded perspective view of the seating plane and display components of the single axis optical assembly of FIG. 3A.

FIG. 3D illustrates a perspective view of the completed single axis optical assembly of FIG. 3A.

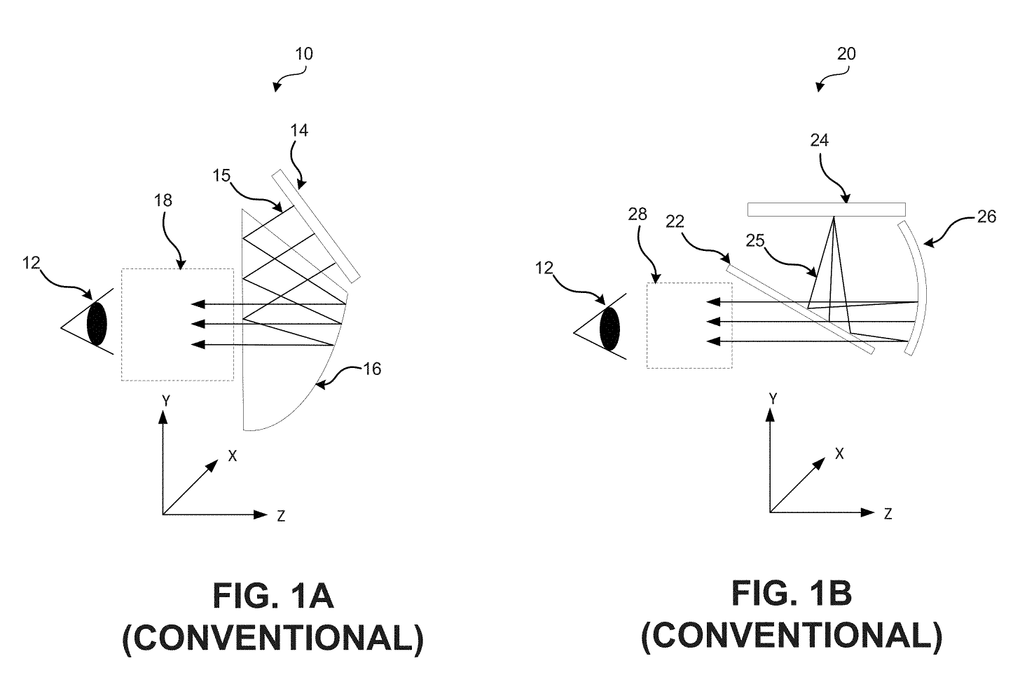

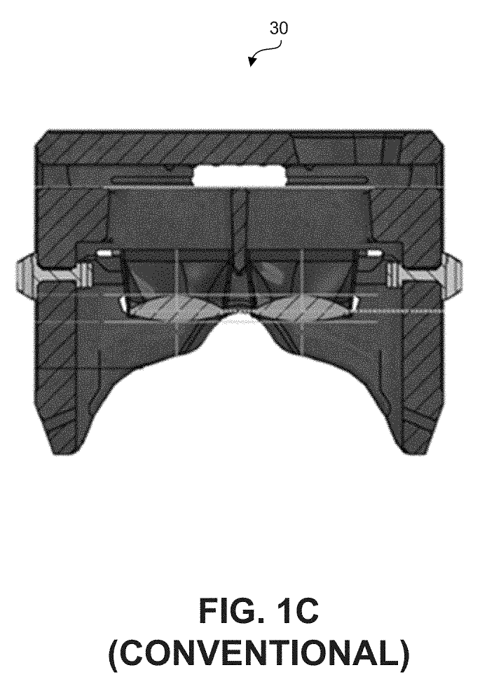

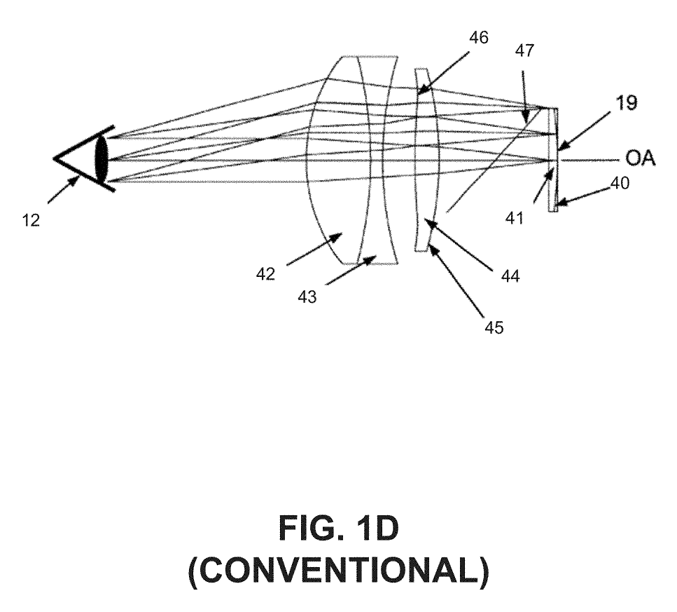

The figures are provided for purposes of illustration only and merely depict typical or example embodiments of the disclosure. The figures are described in greater detail in the description and examples below to facilitate the reader's understanding of the disclosed technology, and are not intended to be exhaustive or to limit the disclosure to the precise form disclosed. It should be understood that the disclosure may be practiced with modification or alteration, and that such modifications and alterations are covered by one or more of the claims, and that the disclosure may be limited only by the claims and the equivalents thereof. For clarity and ease of illustration, these figures are not necessarily made to scale.

### DETAILED DESCRIPTION

The present disclosure is directed to various embodiments of systems, methods, and apparatuses that include a single axis optical system with reduced focal length and TTL that can be utilized in, e.g., an HMD. The details of some example embodiments of the systems, methods, and apparatuses of the present disclosure are set forth in the description below. Other features, objects, and advantages of the disclosure will be apparent to one of skill in the art upon examination of the present description, figures, examples, and claims. It is intended that all such additional systems, methods, apparatus, features, and advantages, etc., including modifications thereto, be included within this description, be within the scope of the present disclosure, and be protected by one or more of the accompanying claims.

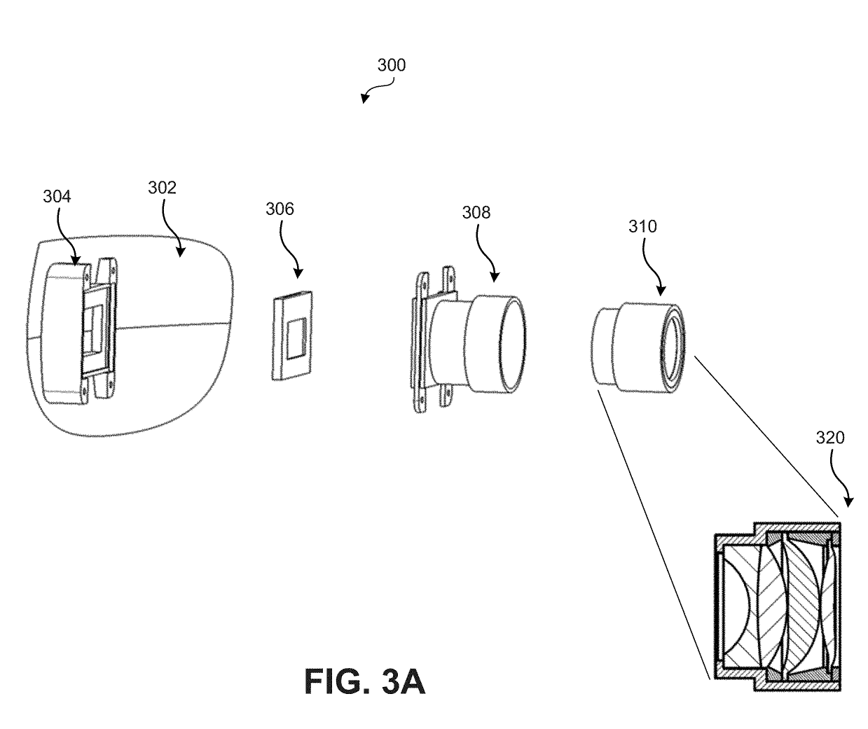

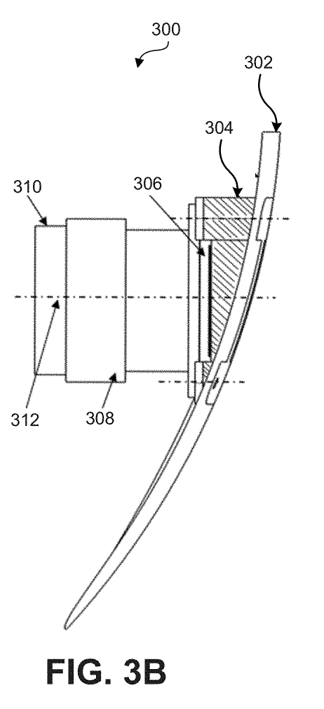

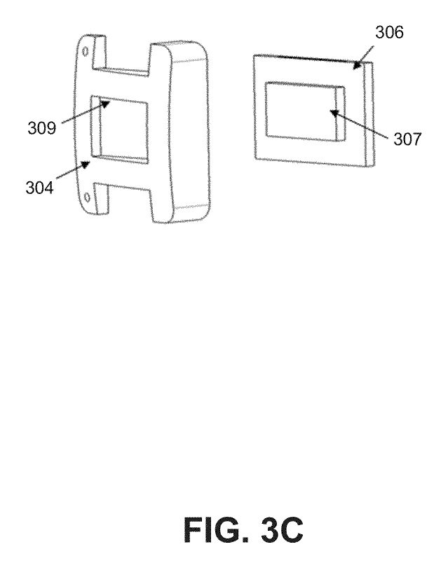

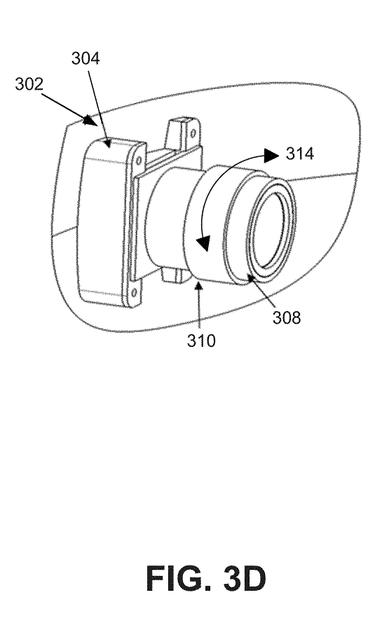

One objective in designing the systems, methods, and apparatuses disclosed herein is to reduce the distance between the pupil of the human eye to a front surface of eyewear/an HMD. This can be referred to as the “optical path.” The optical path may include the following four elements: 1) eye relief distance (a distance from the pupil of the eye to a surface of a lens closest to the eye); 2) total track length (TTL) of the optical system (the length of the optical system measured from the surface of a lens closest to the eye to the surface of a display; 3) thickness of the display; and 4) a mechanical seating arrangement for the display. In one embodiment, these four elements make up the optical system that can define the total thickness of the HMD/eyewear. FIG. 3A illustrates an exploded view of optical system assembly 300 as including, for example, a frame 302 of the HMD, a seating plane 304, for the display 306, a lens holder 308, and a lens barrel assembly with a set of individual lenses precisely assembled to provide the optical characteristics described below. FIG. 3B illustrates a completed optical system assembly 300.

Seating plane 304 may be a part of a “main” frame 302 of the HMD, and configured to have mounted thereon, lens holder 308. Seating plane 304 can be designed such that after the mounting of lens holder 308, display 306 and lens stack 310 remain substantially parallel to each other. Seating plane 304 may also be designed such that when display 306 is mounted, display 306 can be as far as possible distal to the eye of the user (discussed in greater detail below).

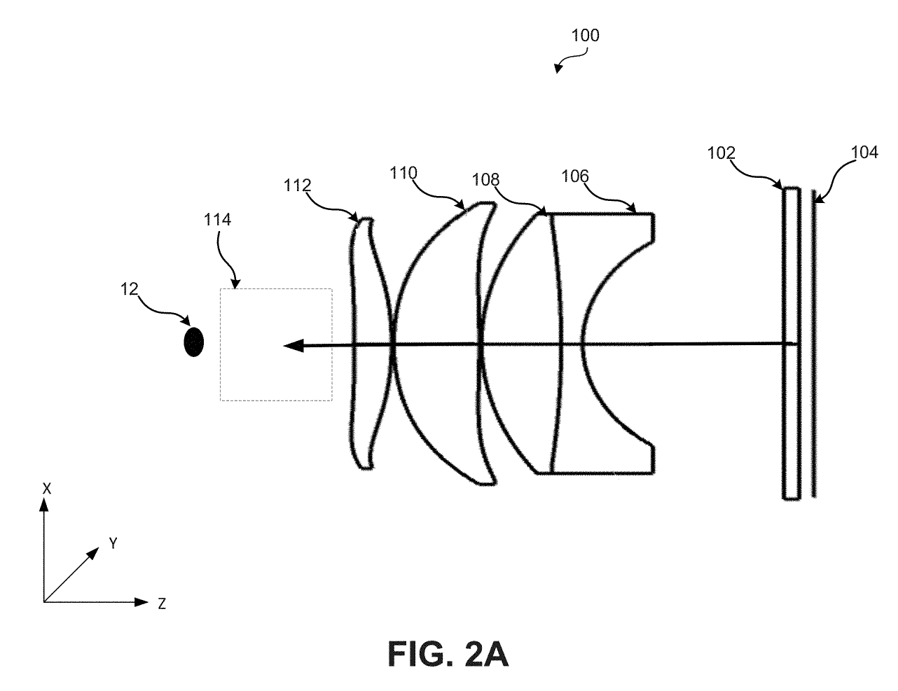

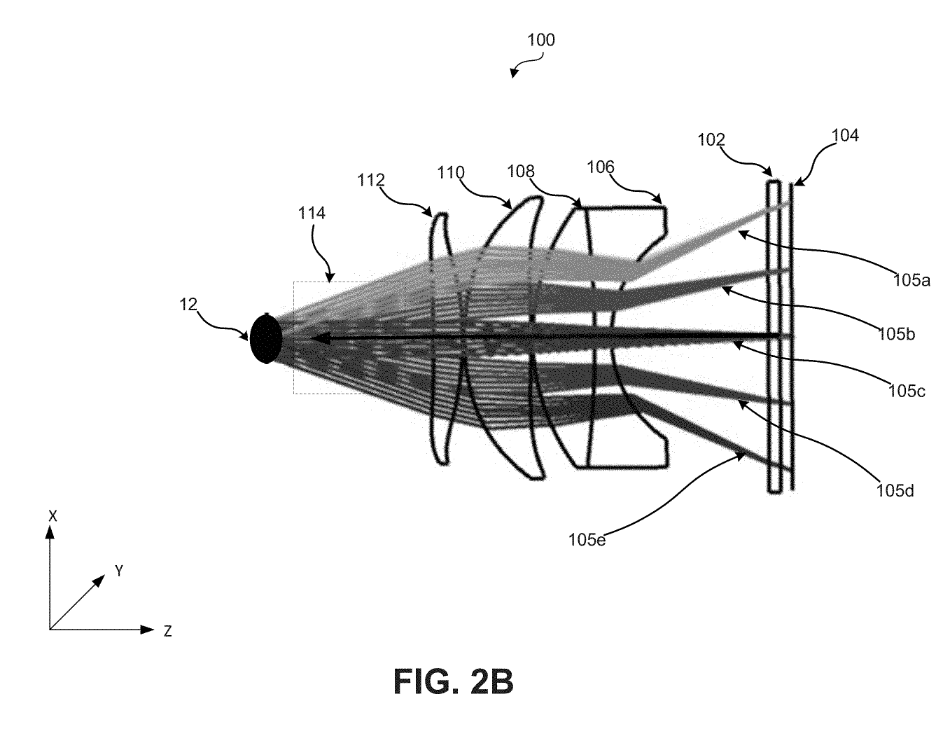

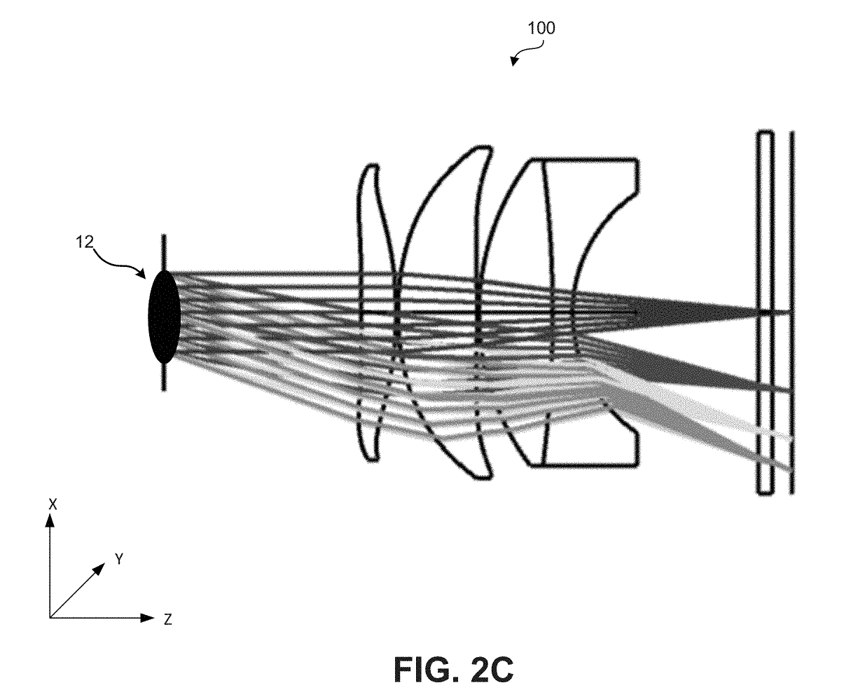

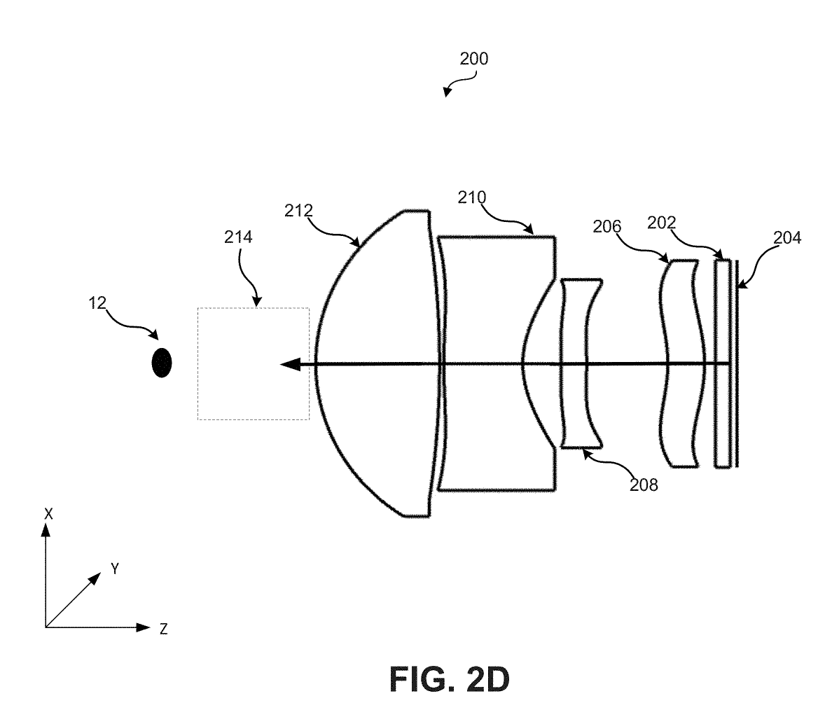

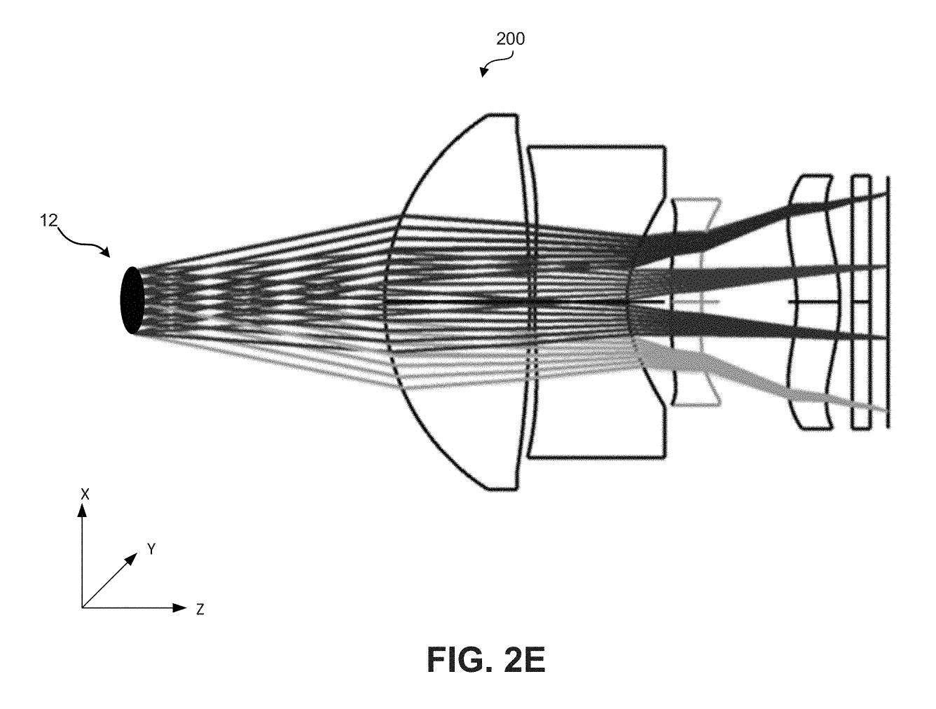

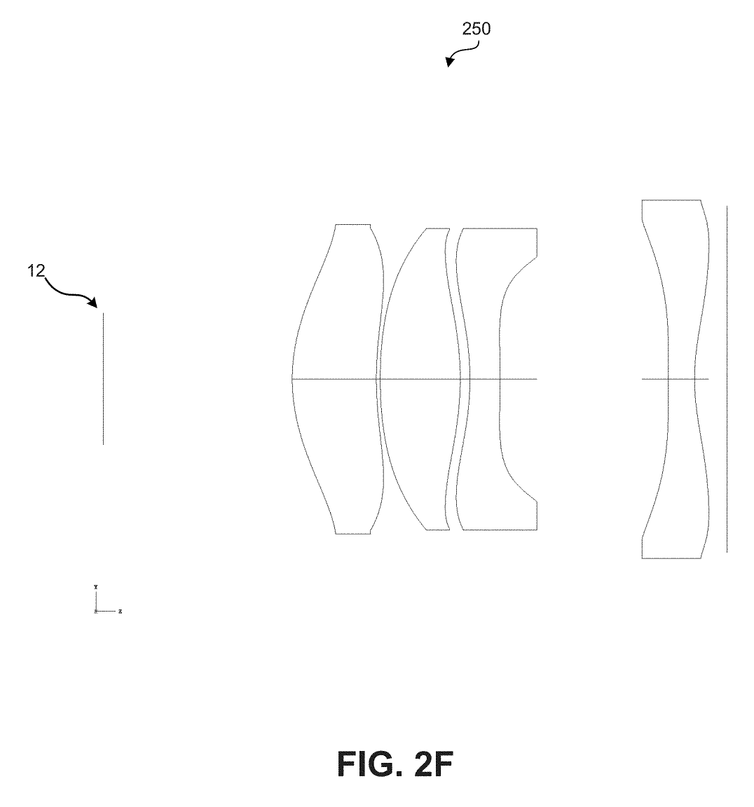

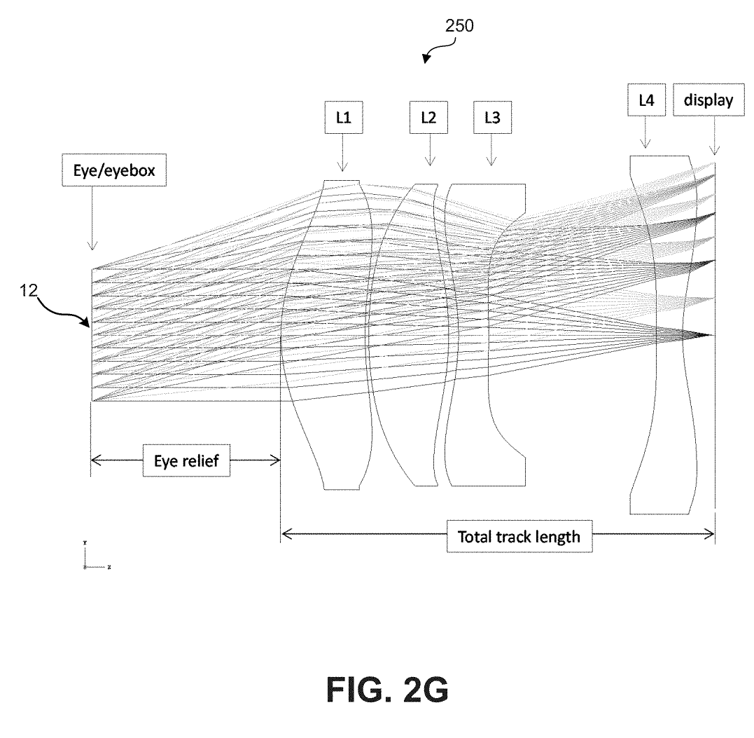

Display 306 (which may be an embodiment of display 102 of FIG. 2A, for example) can be any appropriate display. In some embodiments, the display can be an OLED micro-display.

It is critical to control the offset/misalignment of the display with respect to the optical system. Such misalignment (in X, Y, Z and Theta-X, Theta-Y) can occur in different ways and will impact the performance of the system. The lens holder can be designed with an internally threaded barrel with matching external threads to the lens barrel assembly, which carries the lens system. This arrangement also minimizes any angular misalignment beyond what is allowed by the optical system. The following section describes in detail how this is achieved.

Lens holder 308 may be designed to hold display 306 and lens barrel 310 in place with respect to each other so that it provides a common reference to the light source as well as the optical system. Display 306 can be mounted in a slot (shown in FIG. 3B) provided at the rearward section of lens holder 308. The slot of lens holder 308 can be designed such that the center of display 306 and the center of lens barrel 310 are substantially aligned along the direction of sight axis or optical axis (illustrated in FIG. 3B as hashed line 312). The other hashed lines are axes for where the holder is attached to the frame using threaded screws. This allows for passive alignment, which refers to the ability to align the center points of the display and the optics without an active feedback loop during the placement operation, of the optical center of display 306 with that of the center of the lens stack. In contrast, if the optical elements are placed using active alignment, then the active alignment system continuously receives feedback based on a resulting image until the two are perfectly aligned.

Alternatively, the slot can be made bigger to allow for more accurate, machine-automated placement of display 306 to achieve a higher degree of accuracy. In some embodiments, 1.5 mm high and 1 mm thick walls (not shown) at the rear of lens holder 308 assist in holding display 306 in place, and can be changed depending upon the packaging of display 306. A 0.5 mm thick rubber gasket (not shown) may be added between the surface of display 306 facing lens holder 308 to protect display 306 from dust and damage.

Lens holder 308 may be further provided with four flanges with holes for mounting on the main frame 302 of the HMD using screws or other attachment mechanisms. This mounting scheme eliminates additional parts, such as a separate mounting and alignment scheme for the display, a method to change the distance between the display and the optics to adjust the diopter strength for different users, a separate mounting and alignment scheme for the optics, in addition to any peripheral parts required to provide structural strength to this assembly. reduces the overall thickness of the optics system assembly and keeps all of the components in the optical path relative to the active area of display 306. Moreover, lens holder 308 can be designed such that it follows the contours of frame 302, and keeps the surface of display 306 substantially perpendicular to the optical axis.

Lens barrel 310 can be configured to allow the lens stack to be mounted therein. Lens barrel 310 can provide protection to the lenses that make up the lens stack (e.g., lenses 106, 108, 110, and 112) while maintaining a predetermined distance and tilt/decenter alignment between the lenses. The lens barrel and the alignment spacers tightly control the distance, tilt, and concentric alignment of the lenses with each other.

As illustrated in FIG. 3A, lens barrel 310 has two sections or areas, one with a smaller diameter (closer to the mounting area for display 306), and one with a larger diameter (facing lens barrel 310). The area of lens barrel 310 having the smaller diameter has external threads (e.g., with a 0.35 mm pitch) that allow for the rotational movement of lens barrel 310 within lens holder 308 (when installed) for diopter distance adjustment and assembly. An enlarged cross-sectional view 320 of lens barrel 310 shows lenses installed therein

Display 306, which may be an OLED display in some embodiments, as well as the peripheral electronics included in an HMD (not shown) can emit heat during operation. This can be detrimental to the health of the eyes of the user. Accordingly, various embodiments are configured such that display 306 is positioned as far as possible from the eyes of the user in an HMD. Moreover, any heat generated by display 306 and the surrounding electronics can be carried away from the user by way of a heat slug or heat sink or heat pipe. FIG. 3C illustrates seating plane 304 configured with a slot 309 for a heat slug or heat sink. Display 306 is illustrated as having a heat slug or heat sink 307 attached thereto using thermally conductive material, such that heat can be conducted away from display 306. Heat slug or heat sink 307 can fit matingly within slot 309.

As discussed previously, various embodiments are configured to allow for diopter adjustment. To achieve this diopter adjustment, internal threads (e.g., having a 0.35 mm pitch) are provided along an interior surface of lens holder 308 to accept the external threads of lens barrel 310 described previously. Lens barrel 310 can be held in position by these threads. To adjust diopter/change the diopter distance, lens barrel 310 can be rotated (shown with arrow 314 of FIG. 3D). It should be noted that this adjustment can be made manually by the user or it can be automated with the appropriate mechanical elements/circuitry, although manual adjustment eliminates the additional mechanical elements/circuitry, which in turn reduces the overall form factor. In some embodiments, one rotation of lens barrel 310 contributes to a 0.35 mm change in focus setting (i.e., a diopter adjustment). In some embodiments, the total height of lens holder 308 may be adjusted such that an approximately 4 mm portion of lens barrel 310 protrudes from lens holder 308. This protruded portion of lens barrel 310 provides an area with which the user can grasp or grip lens barrel 310 to effectuate the diopter adjustment. It should be noted that movement of lens barrel 310 to adjust the diopter need not impact the other elements or components of optical system assembly 300 so as to maintain, e.g., the optical alignment of display 306 and the lens stack as discussed above.

The following describes various embodiments related to the optical design of a multi-element lens system assembled in the lens barrel.

To address the shortcomings of conventional HMDs described above, various embodiments utilize a small display in combination with a lens stack that can include a plurality of lenses on a single axis (common with the direction of sight) incorporating spherical and/or aspherical surfaces that collectively create a virtual image from a display while reducing the TTL compared to a conventional HMD (for example, a reduction from a conventional HMD having a 58 mm TTL down to 22 mm).

The optical system is designed in such a manner that an image is projected from a display directly into user's eye(s). There is no need for a relay lens, folded optics, nor any reflective element (such as a mirror or prism). The design is configured such that the eye can see directly through the lens element(s) on same axis.

There are a number of constraints that affect the performance of the optical system. These constraints do not typically exist in conventional HMDS, since there is no requirement to reduce the overall size and weight of the HMD. These constraints include reduced TTL (22 mm in one embodiment), spot size/MTF that matches the resolving abilities of the human eye (@12 cycles degree), Field of View (FOV) to provide an immersive feeling to the user, size of clear aperture to provide the maximum space to the surrounding electronics, and a large eye box. It should be noted that the term eye box can refer to the space of an acceptable viewing window in which the user may rotate the eye (left/right/up or down) while maintaining a view of a complete image on a display.

A variety of lens forms are implemented to satisfy all requirements. In one embodiment, the size of the eye box is considered at 8 mm. The optical system is designed with a minimum number of lens elements that are precisely assembled in a lens barrel (holder) to reduce the size, weight and cost of the HMD system. The result is a simple, cost-effective design with a mechanism which provides the ability to adjust focus to accommodate different diopter requirements of different users, while achieving various optical optimizations and ultimately, a much smaller form-factor HMD.

One such constraint is the eye box, briefly described previously. More particularly, the eye box can refer to the volume of space within which an effectively viewable image is formed by a lens system, representing a combination of exit pupil size and eye relief distance. Alternatively, eye box can refer to the amount of “allowable error” in a viewer's eye position, while still offering a clear target image and a full FOV. An HMD assembly should ensure that light from a display is projected onto the pupil of the user's eye. However, when viewing a digital image in an HMD, it is possible and very likely that the pupil of the user's eye will move, e.g., left, right, up, and/or down to view the digital image at its corners and/or boundaries. Accordingly, an optical system should be designed such that it provides a large eye box in order to account for movement of the user's eyes. In the current invention, we are able to reduce the eye box because we have a mechanical method to adjust the inter-pupil distance, such that each user can adjust the IPD based on his/her own size. If the eye box does not have to account for variations in inter pupil distance between different-sized users, then a much smaller eye box can be designed. This reduced eye box size facilitates a design with a shorter focal length, which helps to reduce the overall TTL of our system. In accordance with one embodiment, a traditional sized eye box of 8 mm can be achieved, which can accommodate eye movement up to about a 10.5-degree rotation in the vertical and horizontal directions. Conventional HMDs with large displays may rely on one or more lenses that have a large aperture, a large eye box, a large focal length, and a correspondingly long TTL. This is purposely done, for example, so that the system is useable by a wide variety of users having different inter pupil distance (IPD, which is normally 57-73 mm in adults) without the need for adjustment, and to account for eye movement, resulting in an eye box of 22 mm, for example. In accordance with various embodiments, the eye box can be maintained at a smaller/more conventional 8 mm (through the use of an adjustable IPD mechanism) which therefore facilitates the optical design of systems incorporating a smaller displays.

In order to achieve a traditional 8 mm eye box and a large FOV, the aforementioned lens stack comprised of a plurality of lenses is used such that the optical system is capable of projecting the virtual image across the entire eye box. The lens stack is designed such that the nominal eye point or “eye relief” (i.e., the exit pupil location) is ˜10 mm from lens 112 (in FIG. 2B, for example). The lens stack is optimized specifically to achieve a short TTL and a comfortable eye relief.

Another example embodiment of a lens design is that shown in FIGS. 2F and 2G. This embodiment has lenses in the unconventional power arrangement, specifically, a +,+,−,− form (going from the eye to the display direction). It achieves the following favorable specifications with good image quality:
1. 10 mm eye relief
2. 8 mm eye box
3. 23 mm TTL
4. 18.356 mm display diagonal
5. 47 deg full-diagonal FOV
6. TTL/EFL=1.128×
7. TTL/display diagonal=1.25×

Another constraint of conventional HMDs that various embodiments of the present application overcomes is referred to as image spot size. Image spot size can be thought of as the minimum area/size visible to the eye. That is, the image spot size from a lens determines the sharpness of the image viewed by the user. The desired image spot size can be based on the resolution and pixel size of the display that is utilized. The effective resolution is based on the resolution of the display and the smallest spot size at any given location within the optical layer. Ideally, we want the optical system (i.e., the lens) to not limit the resolution by the display. For example, if the lens can achieve a spot size is 5 um and the pixel size is 5 um, that means that the optics show at the same resolution that the display is capable of showing. This is considered a well-matched system. In contrast, if the lens can only achieve a spot size at a location of 10 um and the pixel size on the display is 5 um, then the optics can only resolve an area of the size of 10×10 um (approximately an array of 4 pixels). The resolution of the system is then said to be limited by the lens. The spot size will determine sharpness of the image. The criteria for optimizing spot size is to have a spot size less than a two-pixel size of the display. For example, display resolution is lost if the spot size is larger than a two-pixel size because when a lens stack spot radius is larger than two pixels, what should be perceived as, e.g., two dots, will be as a single dot or object to the eye, thereby causing a reduction in sharpness. However, if light from both pixels of the display can be resolved by the lens stack, the eye will see the light or information from each pixel, in this example, two distinct dots.

In order to achieve the smallest image spot radius size, a multiple optical surface system is utilized to correct the wave-front error as the light wave propagate through the lens and air. In addition, different glass or plastic materials that have different dispersion property will help to correct and compensate for the aberrations as the light propagates through the optical system.

It should be noted that optical systems in accordance with various embodiments can be adapted to varying display sizes, both large and small. For example, the optical systems described herein are contemplated for a display having a 0.7-inch diagonal active area. It should be further noted that the optical systems described herein can be utilized with HMDs having a cover glass over/on the display as well as cover-less displays, which can improve (shorten) the overall TTL of the optical system.

Additionally, in order to achieve a small image spot size (i.e., something commensurate with resolving the Nyquist frequency of a display), an optical system having a larger TTL may be needed. In order to form an image, we need to focus the light to smallest spot size and to get this done in short TTL, can require very short radii of curvature lens surfaces. It is known that short radius curvature lens will have limitation in real world manufacturing. Therefore, with similar refractive index lenses and limitation in radius of curvature, the achievable focal length will be larger. Thus, a larger TTL is needed. In accordance with one embodiment, the optical system is optimized to achieve the smallest TTL possible. Alternatively, when a smaller TTL is desired, a lens material that has a higher refractive index can be used to focus the light from a display at distance shorter than that achieved in conventional HMDs. That is, a lens material having a higher index lens can be used. Typical optical grade glass is having refractive index from 1.3 to 2 and for plastics optical lens material the refractive index is even limited to range of 1.4 to 1.65.

Yet another constraint is that associated with how close the optical system can be positioned to the user's eye(s). That is, various embodiments described in the present disclosure position the optical system as close as possible to the user's eyes without contacting the user's eyelashes. Typically, this constrains the distance of the optical system to the user's eyes to about 8-10 mm from a pupil of a user's eye.

In accordance with one embodiment, a near-field single axis optical system that can provide reduced TTL, may be comprised of four lens elements that create a lens stack. The four lens elements may comprise some combination of glass and plastics lenses. The lens stack may have a first lens and a second lens which forms a doublet with a negative focal length. Thereafter, separated by an air gap, the third and fourth lenses each have a positive focal length, each of which are separated by an air gap, and are configured such that the exit pupil is set across the eye box window.

To design such lenses with such requirements, multiple configurations of the optical axis are considered simultaneously during the optimization. Moreover, other parameters such as focal length, spot size, aberrations, eye relief, etc. are considered as well, where different weights or importance can be applied to various parameters while still catering to the eye box optimization to provide a sufficient eye box to a user. That is, optimization can be adjusted depending on desired optical/performance characteristics. For example, spot size may be slightly sacrificed for smaller TTL or vice versa, while still maintaining the desired eye box.

Each of the lens surfaces can be spherical, aspherical, or some combination of both. The lens combination in this preferred embodiment is designed such that the optical power of each individual lens will have negative-positive-positive focal length to achieve smallest spot radius while maintaining a large FOV. Such a combination also achieves a shorter total track length. The shape and radius of curvature is not limited as in figure shown below, but the end result of the combination of each lens' optical power will achieve the target result.

FIG. 2A is a top view of an optical system 100 in accordance with this embodiment. Optical system 100 may include a display cover lens 102 and a display (light source) 104. The aforementioned lens stack may include, as described previously, four lenses. A first lens 106 and a second lens 108 can be combined to form a doublet with a negative focal length. The lens stack may further comprise a third lens 110 and a fourth lens 112, each of which have a positive focal length. Light from the display will be collected by the lens stack in such that it will create a virtual image at 10 feet. In one embodiment, an optimal combination includes a negative power doublet followed by two positive lens. There could be other combinations if four lens elements are utilized. In other embodiments with four lenses, the combination of lens can include two positive lenses followed by a negative lens, and subsequently with another positive lens. At least one negative lens in the lens stack is used in order to achieve such a result.

There may be certain constraints or design considerations associated with the design of such an optical system that is utilized in conjunction/integrated with a display in an HMD, such as an organic light emitting diode (OLED) display. Although other displays may be utilized, the use of OLED displays has become popular due to their high contrast ratios, low power consumption, and weight. These constraints can work against the objective of a simplified HMD assembly, reduced TTL, and superior image quality in the context of conventional HMDs. However, various embodiments of the present disclosure can overcome such constraints.

Referring to FIGS. 2B and 2C, it can be appreciated that the image/light rays 105a-e enter, in accordance with above-described embodiment, the doublet made up of first and second lenses 106 and 108 results in image/light rays 105a-e. Passage of the image/light rays through lenses 110 and 112 results in image/light rays 105a-e.

Referring to FIG. 2D, an alternative embodiment of an optical system 200 is illustrated. Optical system 200 is shown as comprising, for example, a display cover lens 202, a display 204, and four lenses, 206, 208, 210, and 212. In this embodiment, lenses 206 and 208 each have a positive focal length. Lens 210 may have a negative focal length, while lens 212 may have a positive focal length. Again, each of lenses 206, 208, 201, and 212 may have spherical, aspherical, or a combination of spherical and aspherical surfaces. FIG. 2E depicts an example propagation of light/image rays through optical system 200.

FIG. 2F illustrates another alternative embodiment of an optical system 250, and FIG. 2G illustrates an example propagation of light/image rays through optical system 250.

In still other embodiments, more than four lens elements may be utilized. That is, so long as the aforementioned optimization can be achieved with a combination of lenses.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described example embodiments, and it will be understood by those skilled in the art that various changes and modifications to the previous descriptions may be made within the scope of the claims.

What is claimed is:

1. A system, comprising:
first and second displays; and
a plurality of optical lens elements, in combination, a positive focal length and a negative focal length to guide light rays representative of an image generated by each of the first and second displays to achieve an eye box on each of the user's eyes smaller than 10 mm, and an inter-pupil distance adjustment to substantially match the distance between the two eye boxes with the distance between the user's eyes.

2. The system of claim 1, wherein the display and the plurality of optical lens elements are positioned in a single axis commensurate with a line of sight of an eye of the user.

3. The system of claim 1, wherein the display comprises an organic light emitting diode micro-display.

4. The system of claim 1, wherein one of the plurality of optical lens elements comprises a glass lens.

5. The system of claim 1, wherein one of the plurality of optical lens elements an aspherical surface.

6. The system of claim 1, wherein first and second optical lens elements of the plurality of optical lens elements positioned closest to the display both have negative focal lengths.

7. A system, comprising:
first and second displays; and
a plurality of optical lens elements, in combination, a positive focal length and a negative focal length to guide light rays representative of an image generated by each of the first and second displays to achieve an eye box on each of the user's eyes smaller than 10 mm, and an inter-pupil distance adjustment to substantially match the distance between the two eye boxes with the distance between the user's eyes;
wherein third and fourth optical lens elements of the plurality of optical lens elements each have a positive focal length, and wherein the user's eyes are not more than about 15 millimeters from the fourth optical lens element.

8. The system of claim 7, wherein at least one of the third and fourth optical lens elements are made of glass.

9. The system of claim 1, wherein a first optical lens element of the plurality of optical lens elements positioned closest to the eye box has a positive focal length, a second optical lens element of the plurality of optical lens elements positioned on a side of the first optical lens opposite the display has a positive focal length, a third optical lens element of the plurality of optical lens elements positioned on a side of the second optical lens opposite the first optical lens has a negative focal length, and a fourth optical lens element of the plurality of optical lens elements positioned on a side of the third optical lens opposite the second optical lens has a positive focal length.

10. The system of claim 1, wherein the eye box is approximately an 8-millimeter eye box.

11. The system of claim 1, wherein the plurality of optical lens elements is configured to achieve an image spot radius based upon a resolution and pixel size of the display.

12. A head mounted display (HMD) system, comprising:
a frame;
a seating plane integrated into the frame;
a lens holder fixedly mounted to the seating plane and configured to adjustably hold a lens barrel in which a lens stack is integrated to provide rotatable diopter adjustment, the lens stack comprising a plurality of lenses, wherein each of the plurality of lenses are configured such that, in combination, a positive focal length and a negative focal length are provided to guide one or more light rays representative of an image generated by a display mounted in the lens holder, wherein the lens stack is positioned along a line of sight axis of an eye of a user of the HMD system such that surfaces of the lens stack are perpendicular to the line of sight axis of the eye of the user.

13. The HMD system of claim 12, wherein the seating plane is configured to maintain the display and lens stack in a position parallel to each other.

14. The HMD system of claim 12, wherein the seating plane comprises a heat slug slot adapted to receive a heat slug mounted on the display.

15. The HMD system of claim 12, wherein the lens holder comprises a first material facing away from the user's face, the first material comprising a good thermal conductor with a high radiation efficiency, and a second material facing towards the user's face, the second material comprising a poor thermal conductor with a low radiation efficiency.

16. The HMD system of claim 12, wherein the lens holder is configured to hold the display and the lens barrel such that a center of the display and an optical center of the lens stack are maintained in passive alignment, and wherein the lens holder comprises PC-ABS and the optical center comprises polycarbonate.

17. The HMD system of claim 12, wherein the display comprises an organic light emitting diode micro-display.

18. The HMD system of claim 12, wherein one lens of the lens stack comprises a glass lens.

19. The HMD system of claim 12, wherein each lens of the lens stack has at least one aspherical surface.

20. The HMD system of claim 12, wherein third and fourth lenses of the lens stack each have a positive focal length, and wherein the eye of the user is not more than about 15 millimeters from the fourth optical lens element.

21. The HMD system of claim 12, wherein a first lens of the lens stack positioned closest to the display has a positive focal length, a second lens of the lens stack positioned on a side of the first lens opposite the display has a positive focal length, a third lens of the lens stack positioned on a side of the second lens opposite the first lens has a negative focal length, and a fourth lens of the lens stack positioned on a side of the third lens opposite the second lens has a negative focal length.

22. A head mounted display (HMD) system, comprising:
an eyeglass frame;
two seating planes integrated into the eyeglass frame, each of the two seating planes positioned to be in front of and proximate to each eye of a user wearing eyeglass frame;
two lens holders, wherein each of the two lens holders are fixedly mounted to a respective one of the two seating planes and each configured to adjustably hold a lens barrel in which a lens stack is integrated to provide rotatable diopter adjustment, the lens stack comprising a plurality of lenses, wherein each of the plurality of lenses are configured such that, in combination, a positive focal length and a negative focal length are provided to guide one or more light rays representative of an image generated by a display mounted in the lens holder to achieve an eye box associated with each eye of the user capable of replicating natural eye movement of each eye, wherein each lens stack is positioned in line with an optical axis of each eye of the user.

23. The HMD system of claim 22, wherein first and second lenses of each lens stack closest to each display combine to form a doublet lens having a negative focal length, and wherein third lens of each lens stack has a positive focal length and the fourth lens of each stack has a negative focal length.

24. The HMD system of claim 23, wherein each eye of the user is not more than about 15 mm from the fourth optical lens element of each lens stack.

25. The HMD system of claim 22, wherein a first lens of each lens stack positioned closest to each eye box has a positive focal length, a second lens of each lens stack positioned on a side of the first lens opposite the eye box has a positive focal length, a third lens of each lens stack positioned on a side of the second lens opposite the first lens has a negative focal length, and a fourth lens of each lens stack positioned on a side of the third lens opposite the second lens has a negative focal length.
